(19) United States
(12) Patent Application Publication
(10) Pub. No.: US 2005/0131935 A1
(43) Pub. Date: Jun. 16, 2005

(54) Sector content mining system using a modular knowledge base

(76) Inventors: Paul J. O'Leary, San Francisco, CA (US); C. Lee Harris, Mountain View, CA (US); Harold Hernandez, San Ramon, CA (US); David T. Ketsdever, Atherton, CA (US)

Correspondence Address: GERALD B ROSENBERG;NEW TECH LAW, 285 HAMILTON AVE, SUITE 520, PALO ALTO, CA, 94301, US

(21) Appl. No.: 10/992,240

(22) Filed: Nov. 18, 2004

Related U.S. Application Data
(60) Provisional application No. 60/523,062, filed on Nov. 18, 2003.

(51) Int. Cl. G06F 17/00

(52) U.S. Cl. 707/102

(57) ABSTRACT

A content mining system and process utilizes a combination of term recognition and rules-based activity-event classification, performed using a modular database that defines one or more vertical markets or information sectors, to identify sector relevant evidence. The primary elements of the identified evidence are scored in a manner that rates the relevance of a content item with respect to a set of identified nominative entities, a set of activity-based event categories, further associated as sets of entity-event pairs. A database constructed of the scored information provides a relevancy indexed repository of the original unstructured content items.

This application claims the benefit of U.S. Provisional Application No. 60/523,062, filed Nov. 18, 2003.

### BACKGROUND OF THE INVENTION

1. Field of the Invention

The present invention is generally related to content mining systems and in particular to a content mining system and process that combines nominative entity extraction, rules-based activity event classification, and scoring using a modular knowledge base to identify evidence of relevance to a particular vertical market or information sector.

2. Description of the Related Art

In many fields of practical and theoretical research, there is a need to accurately evaluate substantial volumes of information presented in the form of unstructured content, usually presented in the form of or convertible to text. Both the volume and diversity of sources of the textual information make assimilation and extraction of relevant knowledge content difficult.

Various natural language processing (NLP) systems have been proposed to autonomously mine the content and produce usable knowledge indexes. While some systems have met with success in certain circumstances, in many areas of practical research, the production of relevant knowledge indexes has been less than effective. The systems that have been most successful have typically addressed the content of large document collections with the end goals of identifying topics that occur above a statistically significant threshold, of organizing the identified topics into ontologies, resolving the identified topics into existing ontologies, and categorizing entire documents. The resulting knowledge index is, in effect, a monolithic compendium of the potential knowledge contained within the analyzed document collection.

The effectiveness of identifying particular topics is, in general, directly related to the amount of relevant training given to an NLP system. Substantially increased training is required to distinguish and categorically differentiate topics that are syntactically or semantically similar. The time and cost of developing relevant training, particularly where the knowledge of interest in the unstructured content is continually evolving, can and often is a practical impediment to the effective use of content mining systems. Furthermore, additional system customization and targeted training are required to distinguish among specialized topics that, while of low frequency or incidental occurrence in the document collection as a whole, may be of particular relevance in particular research or market segments.

Consequently, there is a need for a realistically supportable knowledge information delivery system that is capable of effectively analyzing a document collection, potentially with content additions occurring in real-time, to identify relevant knowledge specific to particular research and market segments.

### SUMMARY OF THE INVENTION

The present content mining software process and method incorporates term recognition and rules-based classification in combination to form an evidence identification process that culminates in the scoring of all identified evidence in a manner that rates the relevance of a content item with respect to a set of identified corporate entities, a set of event categories, and a set of entity-event pairs.

Evidence for, as an example, corporate entities includes terms and phrases in a document or other source item of content, that is, a content item, that can be definitively associated with (1) a company, or (2) a person, place or thing associated with a company. Such nominative evidence includes, for example, formal and informal proper names. Nominative evidence for companies also includes ticker symbols, CUSIP numbers, and other identifiers, such as phone numbers, email addresses, and Internet URLs associated with the company. The general language in a content item is evaluated to distinguish evidence of actions and events as described in the content item. In the current embodiment, this activity evidence includes language associated with predefined sets of business actions and events, such as earnings announcements, management changes, financing, and other corporate activities. Evidence, both nominative and activity-based, is discerned from content items during a content mining process and then linked or otherwise organized with respect to one or more key nominative or activity-based evidence elements using relational database associations. In the preferred embodiments of the present invention, the association of the collected nominative and activity-based evidence is created and maintained via an authority file for nominative evidence and business events via an event category rules file through a series of evidence resolution and scoring processes.

Evidence associations through the authority and event category rules files are supported by a modular knowledge base that relates the development and deployment of knowledge evidence through the logical information segmentation of discrete data sets within knowledge modules. The modular knowledge base is preferably constructed of two distinct modules of information respectively identified as the master knowledge base and the local knowledge base. Each module consists of a set of data sub-modules with a common data schema so that all are interoperable. The master knowledge base is centrally maintained by its developers, while an instance of the local knowledge base exists at each deployed location, whether a client user location or in a hosted computing facility. In the preferred embodiments, the present local knowledge base is optimized to support the present content mining process within selected vertical markets.

Consequently, an advantage of the present invention is that the significant nominative and activity-based evidence is developed in order to accurately identify sector or vertical market significant information. Furthermore, this developed information can be readily used, subject to personalized end-user profile filtering, to effectively provide a personalized analysis of the unstructured source content documents. The content mining process of the present invention is thereby uniquely capable of supporting the rapid delivery and presentation of information to the end-user in a manner and mode previously unavailable.

For instance, given the specificity of entity-event instance scoring achieved by the present invention, the content mining system of the present invention can extract the individual sentence or sentences in which the entity-event evidence is found, and present those sentences to the user in the form of a document summary. This is particularly valuable when presenting periodic summaries and when delivering those summaries to mobile or other small screen devices. Also, relevant information that matches an end-user's profile can be immediately identified and presented to the user when it exceeds a predefined threshold. The specificity and granularity of the entity-event classification, at the entity and sentence level, allows for the generation of user-specific alerts and document summaries because users only see those sentences or document sections that contain information matching their own stored profile. Finally, by aggregating the stored entity-event data identified in sets of documents, reports can be generated that summarize and identify the most important items for a given entity over a period of time, so as to provide a quarterly or annual report summary.

Another advantage of the present invention is that the authority and related rules-based evaluation of information, coupled with a unifying scoring modules is able to use a modular, distributable, customizable local component database.

### BRIEF DESCRIPTION OF THE DRAWINGS

The forgoing and other objects, aspects, and advantages will be better understood from the following detailed description of a preferred embodiment of the invention with reference to the drawings, in which:

FIG. 1 is a high-level view of the client intelligence system relative to a preferred set of content sources and end-user interface devices.

FIG. 2 is a high-level block diagram of the client intelligence system as implemented in a preferred embodiment of the present invention.

FIG. 3 is a data processing flow diagram illustrating the core segments and processing phases of the content mining system as implemented in a preferred embodiment of the present invention.

FIG. 4 is an example of a content item, as initially received by the content mining system.

FIG. 5 provides a representation of the content item example of FIG. 4 as processed through the standardization phase of the content mining system as implemented in a preferred embodiment of the present invention.

FIG. 6 provides a representation of an authority file data appropriate for use in the further processing of the content item example of FIG. 4 as implemented in a preferred embodiment of the present invention.

FIG. 7 provides a representation of the data output from the term recognition phase of the content mining system as implemented in a preferred embodiment of the present invention.

FIG. 8 provides a representation of an event rule set appropriate for use in the further processing of the content item example of FIG. 4 as implemented in a preferred embodiment of the present invention.

FIG. 9 provides a representation of the data output from the event classification phase of the content mining system as implemented in a preferred embodiment of the present invention.

FIG. 10 provides a representation of the data output from the evidence resolution phase of the content mining system as implemented in a preferred embodiment of the present invention.

FIG. 11 provides a representation of the data output from the scoring phase of the content mining system as implemented in a preferred embodiment of the present invention.

FIG. 12 is a block diagram showing the preferred modules of the master and local knowledge bases as well as the interrelationship between them as implemented in accordance with a preferred embodiment of the present invention.

FIG. 13 is a block diagram of the preferred common components included in a knowledge module as implemented in accordance with a preferred embodiment of the present invention.

### DETAILED DESCRIPTION OF THE INVENTION

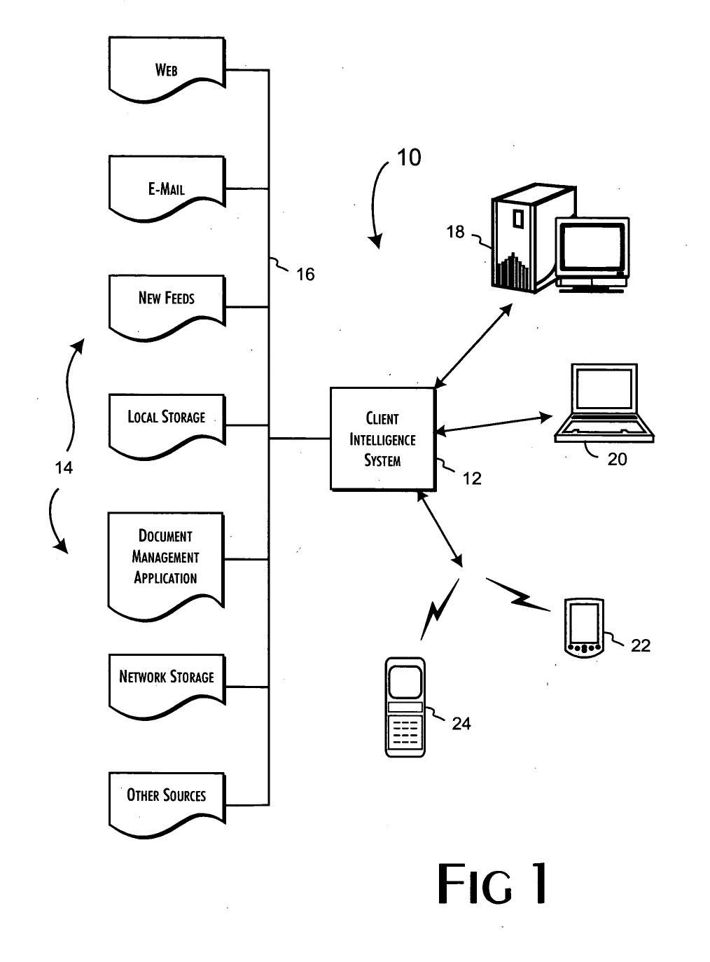

FIG. 1 provides a high-level block diagram of the overall environment 10 within which the client intelligence system 12 preferably operates. A multiplicity of content sources 14, including internal sources, defined as sources located within an enterprise or other organization, and external sources, defined as sources located outside of the enterprise organization typically including web sites, news feeds, subscription services, deliver or provide content to the client intelligence system 12 through the appropriate network connections 16. Various content units, as received from the content sources 14, are processed by the client intelligence system 12 to ultimately produce, personalized for each user, a listing of determined relevant content items. Preferably, the client intelligence system 12 supports a flexible user interface that allows access through any of a range of supported devices, including desktop 18 and laptop 20 personal computers, appropriately configured personal digital assistants 22 and other wireless devices, and appropriately configured cellular phones 24, all with connections to the client intelligence system 12 completed through any necessary and appropriate combination of the conventional wired and wireless telecommunications networks.

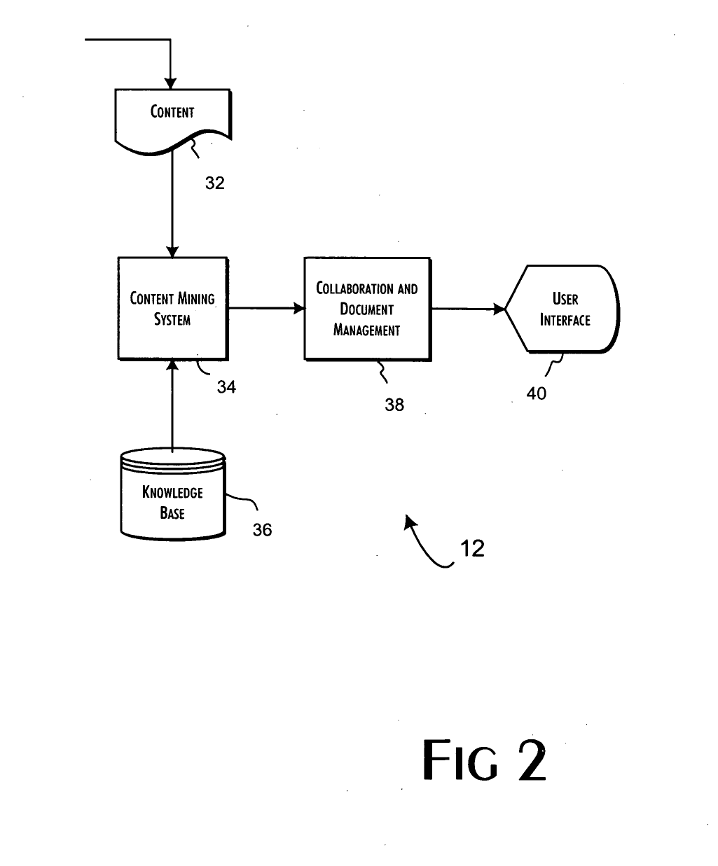

FIG. 2 illustrates the primary components of the client intelligence system 12. The content units acquired from the content sources 14 are collected and provided as content files 32 to a content mining system 34. A knowledge base 36 is provided to support the content mining system 34 in processing the content 32 to identify elements of the content that are significant to identified users of the client intelligence system 12. User-relevant content is processed through a collaboration and document management 38 system to organize and provide the user-relevant content in a convenient manner then accessible to the user through a user interface 40.

Preferably implemented as a series of processing stages, the content mining system 34 initially performs an analysis of the presented content 32 to identify and extract nominative and activity-based evidence. Classification codes are assigned to each item of the extracted and identified evidence. Content 32 containing significant identified evidence, the classification codes and the related metadata are then further conditioned suitably for organization and presentation through the collaboration and document management system 38. Preferably, such conditioning includes the generation of additional metadata identifying the source and date of the original content, as well as each of the content sources from which the evidence was derived,

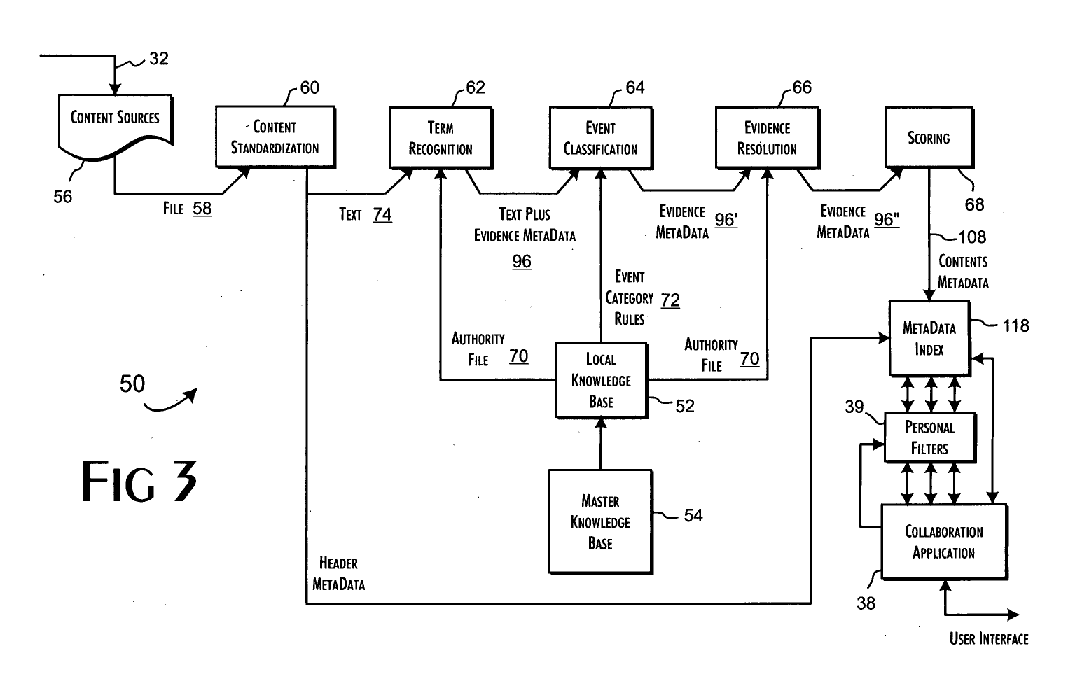

FIG. 3 illustrates the primary components and process flow of the presently preferred content mining process 50. Also shown are the local and master components 52, 54 of the modular knowledge base 36. The objective of the content mining process 50 is to distinguish informative value from the content 32 progressively as the content 32 is collected from the available content sources 14. In accordance with the preferred embodiments of the present invention, personalizations as established by individual end-users, and equivalently groups of end-users, are used to tailor the content mining process 50 with respect to the evidence identified from the content 32 for those end-users.

The content 32 is initially processed through a content source interface 56 that implements the necessary interfaces, connectors, and adapters as required to access the various content sources 14. The received content files 58, as progressively represented by the relevant information contained in the content files 58, are then sequentially processed through the stages of standardization 60, term recognition 62 event classification 64, evidence resolution 66 and scoring 68.

In accordance with the preferred embodiments of the present invention, the local knowledge base 52 implements a selected subset of the master knowledge base 54. The local knowledge base 52 also preferably implements an authority file 70 and event category rule set 72 specific to a particular vertical market. The authority file 70 contains an encoded knowledge representation that is used to identify nominative evidence of entities, such as companies, individuals, places and things, in regard to a particular vertical market. The event category rules set 72 contains an encoded knowledge representation of actions and events that may be associated with any entity in the vertical market. While multiple authority file 70 and rule set 72 pairings for different vertical markets can be stored in the local knowledge base 52, at least one paring is required.

In the preferred embodiment of the present invention, an authority file 70 and rule set 72 pair specific to the financial services sector vertical market is implemented in the local knowledge base 52. The relevant nominative entities preferably include identifications of those corporations, businesses and institutions within the defined financial services sector, the notable individuals and officers of those entities, and the office locations, products, and other things associated with those entities. The event rules preferably operate to distinguish language that relates the occurrence of sector relevant events that may occur in relation to the sector nominative entities, such as the occurrence of mergers, acquisitions, financings, changes of employment, successes and failures to win contracts, sign leases, and make purchases, and the occurrence of office relocations and closings. The class of a specific vertical market can be as narrow as or narrower than, for example, agribusinesses within the Fortune 100 or as broad as all publicly traded companies in the Fortune 1000, which is still considered, in the context of the present invention relative to conventional content mining systems, to be quite narrow particularly where the source content files are drawn from conventional broad document collections, typically delineated only as “current business news.” In accordance with the present invention, the content 32 is processed separately, and potentially in parallel, for each narrowly defined vertical market, as realized by each of pairing of authority file 70 and rule set 72, to ensure distinguishing the evidence of particular relevance to the individual vertical markets.

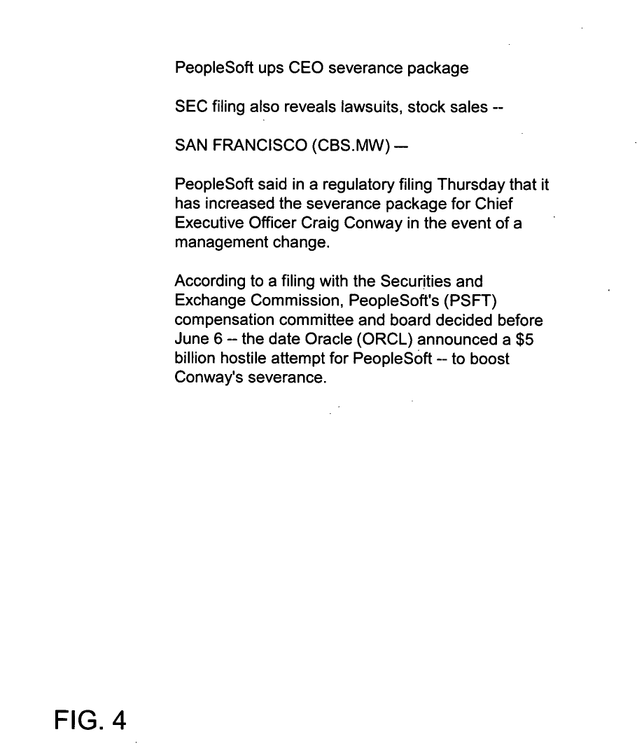

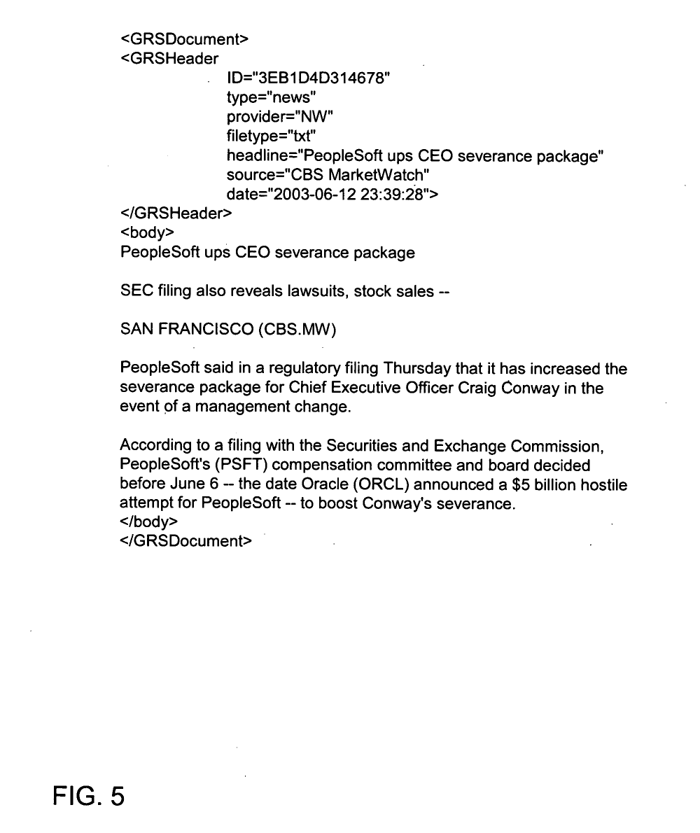

The content sources interface 56 delivers or allows access to files 32 for processing, in a preferred embodiment of the present invention, by a standardization module 60. The stage operation of the standardization module 60 includes accepting files in the received format, as for example shown in FIG. 4, and to convert the file content to an internal standard text file format. As illustratively shown in FIG. 5, the file associated header information is preferably rewritten into an XML wrapper from which all nonessential formatting has been removed.

A term recognition module 62 receives the standardized content text files 74 from the standardization module 60. The stage operation of the term recognition module 62, in a preferred embodiment of the present invention, provides for nominative term recognition using pattern recognition and inferencing engines. Nominative reference data from the authority file component 70 of the local knowledge base 52 is provided to the pattern recognition and inferencing engines of the term recognition module 62. In the case of the preferred embodiment of the present invention, which addresses requirements of users in the financial services sector, the nominative reference data identifies the names of persons, places, organizations, corporate entities, as well as dates, monetary values, and probabilistic significant phrases that may be contained in the standardized content text files 74 as determined by an analytic analysis or domain expert for the particular vertical market addressed by the authority file component 70. In the preferred case of a financial services sector vertical market, the names of people and corporate entities are considered the most important. Markers are, however, associated with each instance of the identified nominative evidence in the standardized content text files 74. Preferably each marker further encodes any applicable date and time references, monetary amounts, and percentages or other attributes identified through the pattern recognition function of the term recognition module 62 as closely associated with instances of the nominative evidence. The nominative evidence and associated markers will be used in the stage operation of the event classification 64 module to match against event category rules 72.

In the current embodiment of the invention, the term recognition function is performed by ThingFinder™, a commercial product licensed from InXight Software Inc. We have also successfully implemented this function in prototype versions using NetOwl™, available under license from SRA International, Inc., and AeroText™, licensed from Lockheed Martin Corp. The event classification function is currently performed using the Lextek Profiling Engine SDK, licensed from Lextek International. This function could also be performed with other standard and commercially available text indexing and search tools, such as those provided by Verity, Inc. and other search engine vendors.

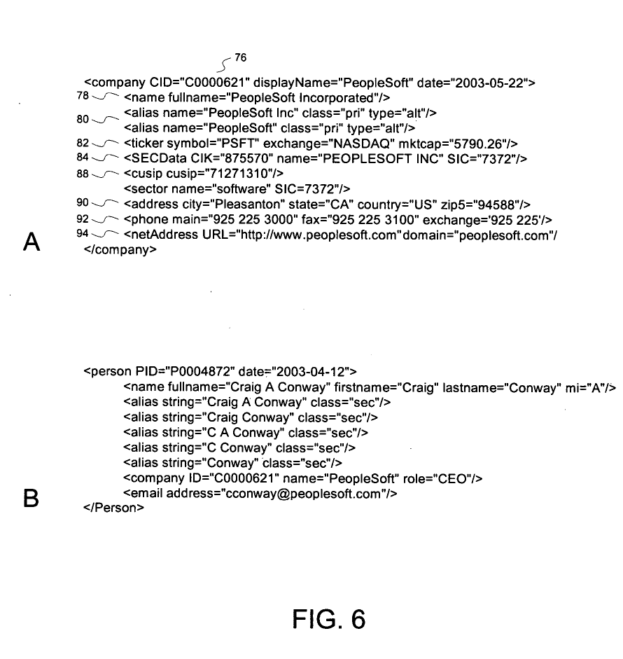

A representation of the preferred implementation of the authority file 70 is shown in FIG. 6A. The authority file 70, in relation to the present preferred embodiment, is preferably comprised of a set of structured records linking names, identifiers, and people to corporate entities. A typical record contains an internal ID 76, for use within the client intelligence system 12, the formal name of the company 78, short form names and colloquial names 80 for the company, the official ticker symbol 82 if the company is publicly traded, the CUSIP number 88 and the SEC CIK 84 number, plus the company's location information 90, phone numbers 92, web addresses 94, and any other similarly identifying information. The authority file 70 also contains a list of people, typically names of the management and corporate officers, and identifications of their roles within the associated company, and the formal and common names for those people. The authority file record shown in FIG. 6B provides an example of the personal data retained. Evidence collected during content mining will be matched against the records in the authority file 70 subsequently during scoring to generate scores for each company-nominative evidence item relationship.

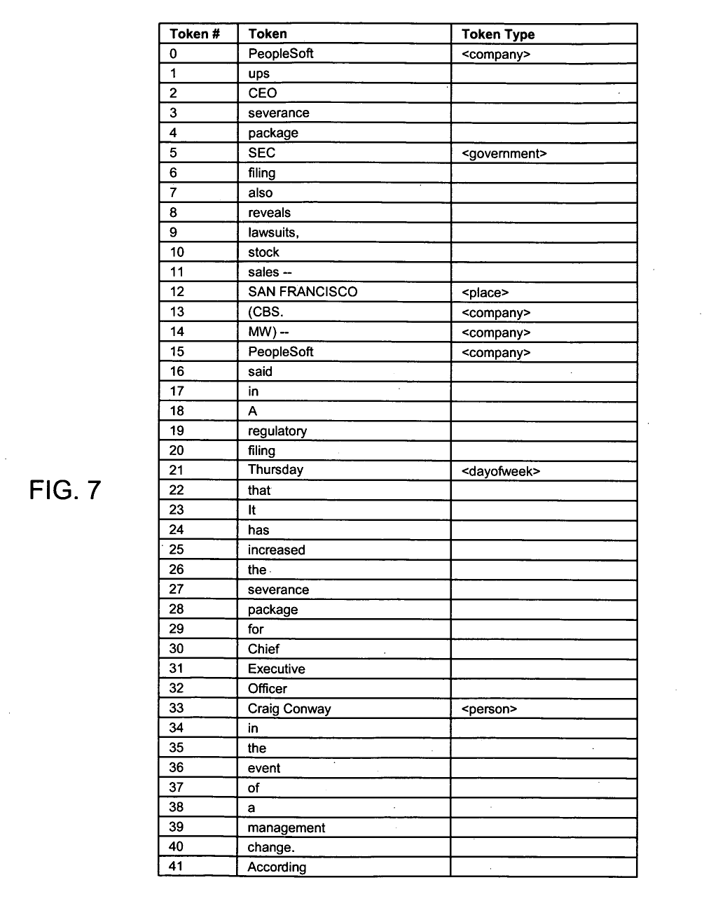

The stage process of term recognition performed by the term recognition module 62 includes tokenization and selective token pattern matching utilizing information from the local knowledge base 52. The product of the term recognition module 62 is a structured evidence metadata record 96 containing every word token in an individual content text file 74, also referred to as a content item, and marker for every item of nominative evidence that has been identified. FIG. 7 is a representation of the data produced by term recognition 18 in FIG. 3.

While term recognition 62 focuses primarily on recognition of proper names and other relatively narrowly defined classes of nominative terms, the event classification module 64 preferably implements a broader text content analysis to identify specific language associated with the nominative evidence that represents or otherwise identifies particular events of interest. The event classification module 64 preferably operates to apply the rules of the event category rules set 72, as provided from the local knowledge base 52. The content line items and the source, content type, and other marker attributes provided by way of an evidence metadata record 96 are evaluated to select and determine the manner of applying individual logic rules from the event category rules set 72 to each content item. Rules associated with specific content types are used to indicate the existence and rate the importance of document structure, how to use header data, and how the location of evidence instances within the body of the document should be subsequently factored into the scoring process.

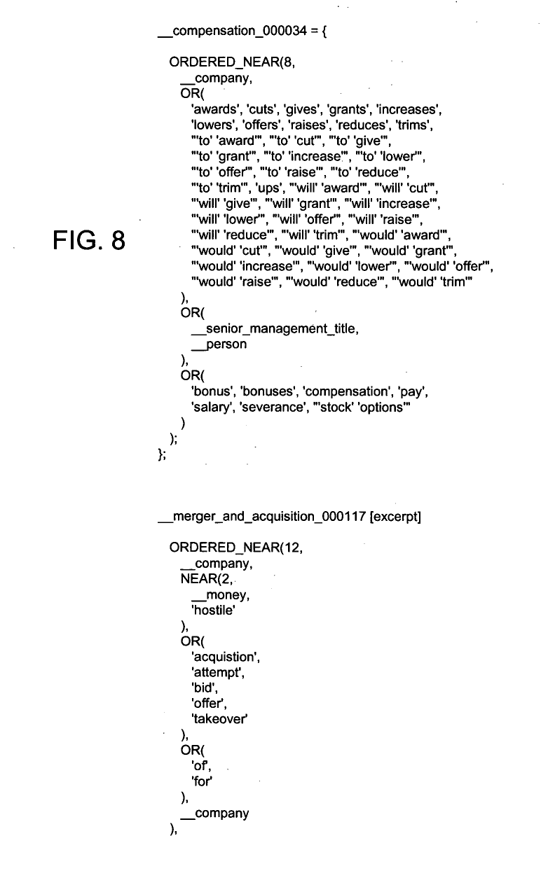

FIG. 8 provides a representation of an exemplary set of the event category rules 72. In accordance with a preferred embodiment of the present invention, the event category rules 72 are represented as stored queries containing word or other token terms associated with specific events and actions. Collectively, these stored queries act as filters through which all content items are processed. The rules are written in an extended Boolean query form, using AND, OR, and the proximity operators NEAR and ORDERED NEAR, in the preferred embodiment of the present invention. Other rule representation syntaxes could be used. Preferably, the rules are constructed using a combination of domain expert term identification and automated collection of statistically significant terms based on training set data. With training, rules can and typically will grow to contain one hundred or more sub-component rules, each containing between fifty and five hundred term nodes. Event rules are designed to be applicable to the categorical events generally applicable within a vertical market. The definitions of event categories can be customized for a particular environment and customer requirements.

In the current embodiment designed for the financial services sector, standard event categories include a range of categories typical of news about companies and industries such as financial performance announcements, research analyst reports, merger and acquisition news, changes in senior management, and new product announcements. Using the text content and evidence metadata 96 as developed by the term recognition module 62, the event classification module 64 operates to identify event activity patterns in the content with respect to each potentially applicable event category. This evidence-based event classification 21 process accomplishes a more fine-grained classification of documents than is conventionally achievable with purely statistical methods. For example, language in a news item associating nominative evidence with an acquisition activity event can be more accurately identified based on the mutual evidence occurrence. In this case, the combination of nominative and activity-based evidence is used to correspondingly associate a code for mergers and acquisitions with the evidence as stored to the metadata record 96.

The stage operation of the event classification 64 module performs two primary functions. First, the event classification module 64 operates to locate textual references to the various activity events defined in the event rule set 72. Second, the event classification module 64 operates to link the identified event activities to the nominative evidence instances identified in the term recognition stage. The rules are designed to identify references to classes of entities, and less commonly to the specific instance of an entity. In other words, the event classification process primarily depends on the references to company or person as classes of proper named entities, using the markers for the classes ‘<company>’ or ‘<person>’. For example, the event rule fragment “<company> names <person> CFO” finds phrases indicating a specific corporate management change event. Thus, at this stage, the metadata record is annotated to generically indicate that a particular activity token is associated by a type of reference to a company, and that this company reference is found in a management change event context. This permits a broad scope of information to be retained in the metadata record 96, while allowing, on subsequent processing of the metadata record 96, the nominative and activity evidence to be fully and accurately resolved to the specific management change event and the specific affected corporate entities,

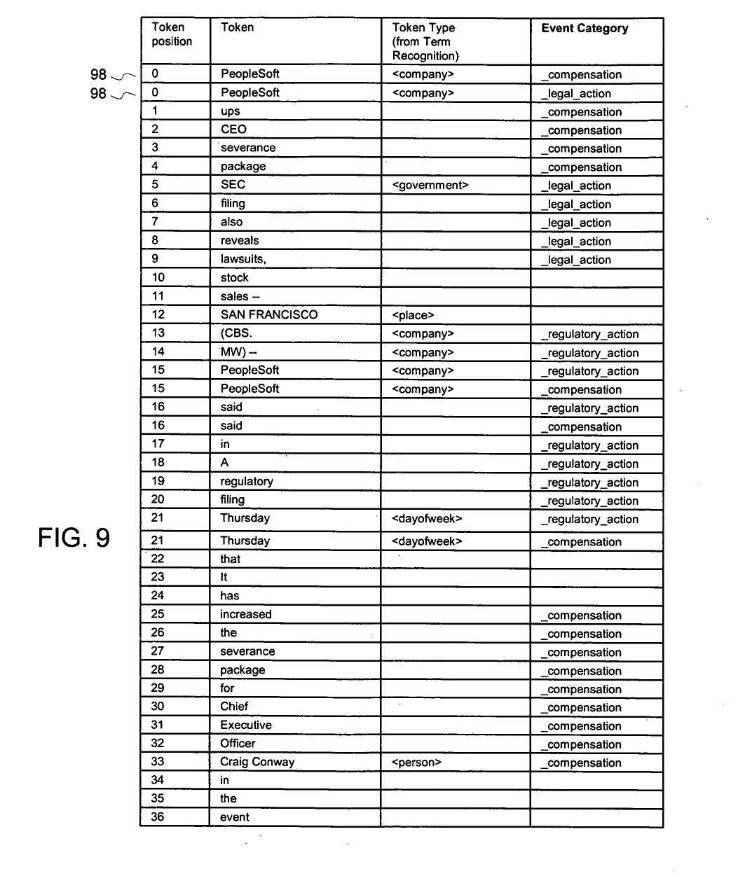

As generally indicated by the metadata record 96 example shown in FIG. 9, a single content item can contain references to multiple different entities and event categories. A single entity token can also be linked to multiple event contexts. For example, the company entity 98 at token position 0 is linked by separate event rules to a “_compensation” event and a “_legal_action” event. Each element of event category metadata is preferably considered an independent data item. The event category data will be used during the subsequent scoring process to accrue event scores linked to specific corporate entities. At the end of processing by the event classification module 64, the metadata record 96′, incorporating the classification information, is passed on to the evidence resolution 66 module.

The primary operation of the evidence resolution module 66 is to assign unique identifiers to the nominative evidence entities found by the term recognition module 62. In other words, evidence resolution module 66 performs an automated analysis that determines whether the identified nominative evidence can be definitively associated with a specific, known entity. The evidence resolution process attempts to unambiguously link proper names to the unique identifiers, whether company IDs, person IDs, or other entity IDs, against the identifies present in the authority file 70.

On partial or potential matches, the evidence resolution module 66 further operates to determine whether secondary or ambiguous name evidence can be disambiguated to provide a sufficient basis to promote the identifier match to primary evidence status. In accordance with the present invention, primary evidence is text evidence in a content item that is independently and unambiguously associated with a specific known entity. Examples of primary evidence are unique company names, corporate web and email addresses, and company telephone numbers. Secondary evidence is text evidence in a content item that is potentially associated with a specific entity. Non-unique or ambiguous forms of a company name and names of corporate officers are examples of secondary evidence.

Secondary evidence for a company or person is promoted to primary evidence status when other primary, i.e., definitive and unambiguous, evidence for that nominative entity is also found in a content item. Also, when two distinct items of secondary evidence are found in close proximity, then these evidence items are promoted to primary status. In other words, secondary evidence requires that other evidence, primary evidence or adjacent secondary evidence, be present in the content item before the evidence can be definitively linked to a specific nominative entity.

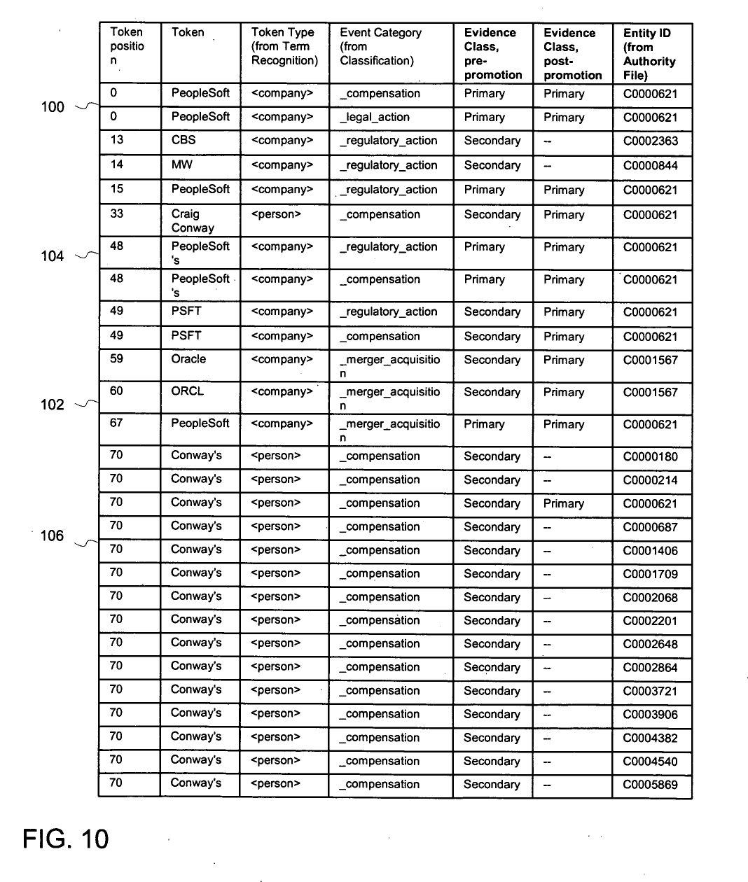

A representation of the metadata record 96′, as further modified by the evidence resolution stage operation is shown in FIG. 10. In the exemplary resolved metadata record 96″, the terms PeopleSoft 100, at token position 0, and Oracle 102, at token position 59, are shown linked to corporate entities. In the process of developing the knowledge base 36, the nominative term PeopleSoft is classified as primary based on the definite association with the corporate entity PeopleSoft Incorporated as determined through a statistical analysis of a large training collection of documents. The nominative term Oracle is comparatively identified as secondary evidence for the company Oracle Corporation on the balanced basis that the nominative term exists as a common word in the English language and the statistical analysis of the training documents does not conclusively associate this term solely with the corporate entity.

An occurrence of evidence promotion is illustrated in FIG. 10 relative to the nominative person names Craig Conway 104, at token 33, and the possessive nominative term Conway's 106, at token 70. Both of these nominative terms are initially classified as secondary evidence in the knowledge base 36. The instances of these nominative terms in the resolved metadata record 96″ are promoted to primary status by operation of the evidence resolution module 66 based on the existence of the independent primary evidence for PeopleSoft, Inc. in the resolved metadata record 96″ and the association of the nominative term Conwaywith PeopleSoft, Inc. preestablished in the knowledge base 36. That is, while the nominative entity term Conway, being a fairly common name, is not uniquely associated PeopleSoft, Inc. in the knowledge base 36, the combined occurrence of PeopleSoft, Inc. as primary evidence and variants of Conway closely occurring in the same evidence metadata record 96′ is considered a sufficient basis to resolve the initial ambiguity and promote the various Conway nominative term variants to primary evidence status and linking each of the nominative term variants to a single unique identifier for scoring.

The final processing stage of the content mining system 34 is performed by the evidence scoring module 68. Resolved evidence metadata records 96″, as received from the evidence resolution module 66, are analyzed to produce sets of evidence nominative entity-activity event scores 108 for each of the content items. In the preferred embodiments of the present invention, cumulative scores 108 are generated by stepping through each received metadata record 96″ accumulating instance scores for each evidence nominative entity-activity event pair.

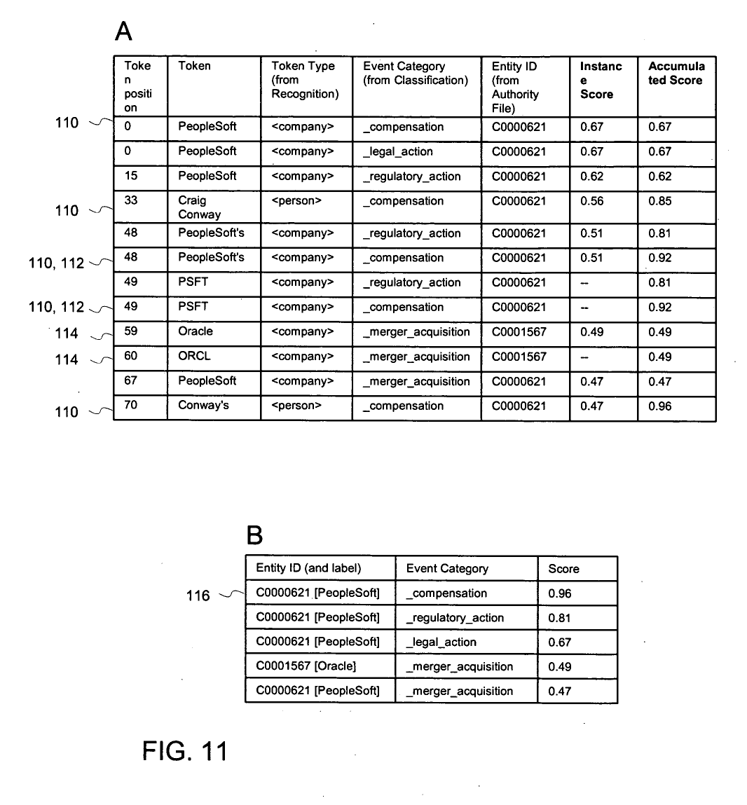

A representation of an exemplary set of instance and accumulated scores for entity-event pairs is shown in FIG. 11. In accordance with the preferred embodiments of the present invention, only primary evidence, either as initially established or as promoted to primary status through the evidence resolution stage, is subject to scoring. Each instance of primary evidence is scored based on document position using a token count distance metric. In the preferred embodiment of the present invention, the following default formula is used, where the first token in a content item is counted as token zero and the document length is counted as the total number of tokens occurring in the content item.
instanceScore=0.67*(1−tokenPosition/totalTokenCount)

This default formula may be modified, as appropriate so as to account for short documents, such as by document length normalization, and documents that incorporate multiple, otherwise independent event relevant documents, such as by source fragmentation, in order to handle conditions particular to the content sources.

The score for each evidence nominative entity-activity event pair is accumulated in the preferred embodiments using this formula:
accumulatedScore=accumulatedScore+((1−accumulatedScore)*instanceScore)

Referring to the example representation shown in FIG. 11A, the evidence nominative entity-activity event pair 110 for C0000621 and “_compensation” is found at token positions 0, 33, 48, 49, and 70. The instance scores for this pair are accumulated resulting in a content item score 116 of 0.96, as shown in FIG. 11B. The two adjacent items of evidence of the same type and in the same event class are considered to be effectively in the same position and are not both scored. For example, the evidence tokens 112 at position 48 and 49, as well as the tokens 114 at positions 59 and 60 in FIG. 11A are treated as evidence of the same event and so only the first evidence token is scored in each case.

The entity-event instance scoring and the score accumulation algorithms described here are distinct from the conventional, statistically-based methods of text classification, including TF/IDF, Bayesian, and K-nearest neighbor. These conventional methods score documents based on the statistical analysis of patterns of textual features, typically terms and phrases, in documents and collections of documents. The statistical text classification methods require a training set of pre-classified documents to train the classifier before new, unclassified documents can be processed. The method described here uses the output from the previously described term recognition and rules-based event classification stages without the use of training sets or statistical analysis. The process of developing the knowledge base 36 does use training sets and statistical methods, but that process is a distinct and precursory process relative to the process implemented by the content mining system 34 described herein.

The final scores assigned to a content item are the set of accumulated scores for each evidence nominative entity-activity event pair, as generally shown in FIG. 11B. These final scores are then incorporated into final metadata records 108 generated for each content item. The content items 32 and final metadata records 108 are then stored in a content and metadata index database 118 and made available to further applications, including the collaboration and document management application 38 directly and through, in accordance with the present invention, an active filter 39. In a preferred embodiment of the present invention, the active filter 39 maintains sets of personal end-user filter profiles that are, in effect, continuously evaluated against updates to the content and metadata index database 118. Depending on the individual elements of the end-user profiles, automated filtering, routing, and alerting functions can be performed on a per-end user basis. That is, given that the feed of content items 32 is performed in real-time, the metadata index 118 can be progressively evaluated to identify evidence nominative entities and activity events deemed relevant according to per-end-user established profile 39 settings. Thus, for example, an individual end-user can monitor, effectively in real-time, for the occurrence of any activity involving a particular nominative entity or set of entities, any particular activity event or event category, or any desired combination thereof.

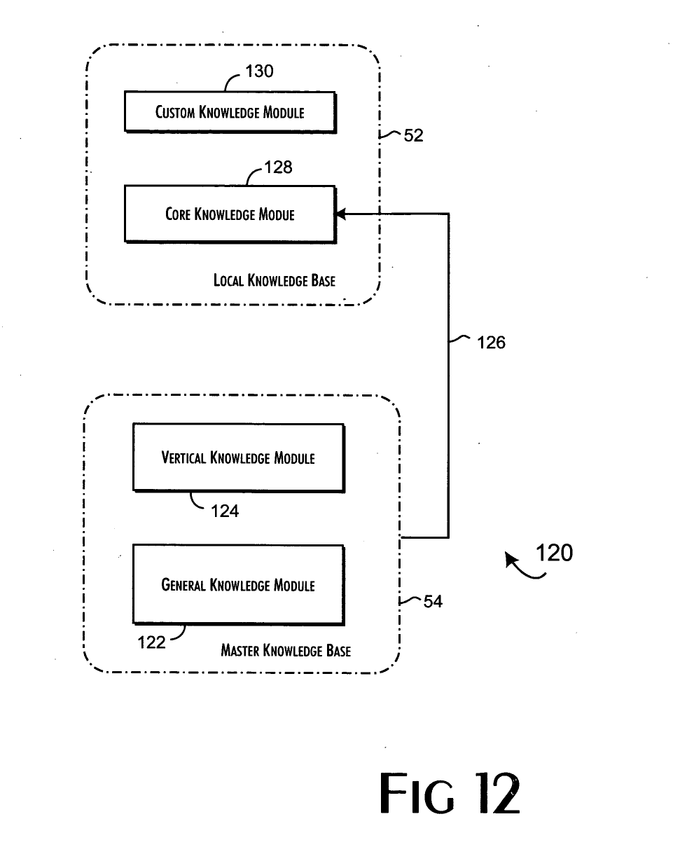

FIG. 12 depicts the vertically focused local knowledge base 57, which is a key differentiator of this content mining embodiment. Unlike the substantially nondescript general knowledge bases available for some products, such as WordNet and Cyc, or the knowledge base development kits that require a substantial organizational investment of human and financial resources, the local knowledge base is a robust and vertically optimized product that ships with the application. Additionally, the ongoing centralized knowledge base research and development process offers subscribers the opportunity to routinely upgrade their local knowledge base for a fraction of the cost of an in-house development staff or a contract development group. It is also extensible, with a framework that allows for proprietary and internal corporate data to be added and leveraged by the application components. Updates to master knowledge base 50 data will occur on an ongoing basis with periodic publishing of updates to the distributed subscriber base.

The knowledge base 36, in the preferred embodiments of the present invention, includes the local knowledge base 52 and master knowledge base 55. The master knowledge base 54 is preferably a single, centrally located database that includes a general knowledge module 122 and a set of one or more vertical knowledge modules 124. In the current preferred embodiment, the general knowledge module 122 includes rules that identify general syntactic language patterns, such as parts of speech, and general semantic patterns, including nominative entities and patterns representing monetary figures.

The local knowledge base 52 is preferably a distributed database of nonidentical instances. Each instance is derived from the master knowledge base 54 so as to be tailored to the particular business needs of a subscribing client, typically a corporate or other business entity. In deriving an instance of the local knowledge base 52, one or more of the vertical knowledge modules 124 and an appropriate portion of the general knowledge module are transferred 126 into a core knowledge module 128. The resulting instance of a local knowledge base 52 will then be distributed to the client company's computer systems or to a hosted computing facility that operates as an agent of the client company. Typically then, the local knowledge base 52 instances are geographically separated from the master knowledge base 54.

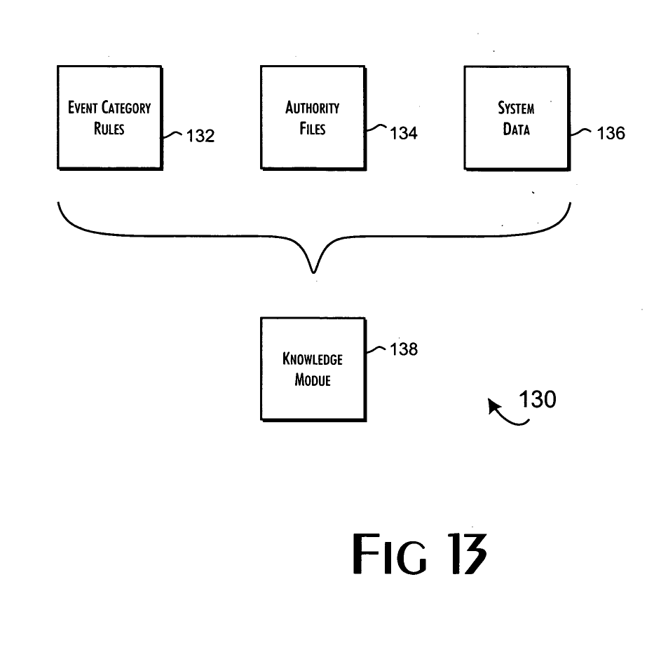

The process of deriving an individualized core knowledge module 128 is shown in FIG. 13. One or more vertical markets can be identified from the specific business requirements necessary to satisfy the end-user specified profile requirements within a subscribing client. The event category rules 132 and authority files 134 comprehensive to the identified vertical markets are then selected and, together with system configuration and control data 136 are merged into an individualized core knowledge module 138. In a preferred embodiment of the present invention, system configuration and control data 136 includes available and selected content source information, vertical market default settings, and other configuration information appropriate to allow use of the core knowledge module 138 by a content mining system 34.

To complete the construction of an individualized local knowledge base 52, optionally subscribing client provided information can be compiled into a custom knowledge module 130 having a form and content consistent with the structure and content of the core knowledge module 128. Thereafter, the custom and core knowledge modules 128, 130 can be accessed together by the content mining system 34 to support the generation of the content and metadata index database 118. Additionally, the custom knowledge module 130 can, in a preferred embodiment of the present invention, be updated by the subscribing client with information of specific relevance to the subscribing client.

Thus, as described above, the preferred embodiments of the present invention are designed to support detailed and accurate identification of sector relevant information, such as, in the context of the financial services sector, identifications of the corporate entities and the business events of potential interest to investors and financial services professionals. The integration and support of end-user profiles allows personalized representation and reporting of the sector relevant information on an ongoing basis. Analysis of other sectors and sectors that intersect with or are a subset of the financial services sector can also be supported by the present invention. For example, the authority file component of the knowledge base can contain significantly different types of nominative entities as the primary entities of interest, such as persons, products, diseases, drugs and chemicals, nations, and political entities. The event rules can be used to define event rule patterns linked to actions and events specific to these other classes of entities. When paired to define a vertically-focused or domain-specific knowledge base, the content mining process of the present invention can be used to develop and deliver personalized identification of information in these other markets and information domains.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A sequential textual analysis system operative to identify in a document a set of named entities and correspondingly associated events, said sequential textual analysis process comprising:
a) a named entity extraction component operative to identify names in a document, said named entity extraction component being further operative to associate each identified name with a name class identifier of a set of name class identifiers;
b) a text classification component operative to analyze said document to identify event identifiers, representative of selected content of said document, having predetermined associations with said set of name class identifiers, said text classification component producing a set of entity-event pairs;
c) a logic component operative to resolve ambiguous name class identifiers relative to said set of entity-event pairs, said logic component including a knowledge base of known names and names variants, said logic component producing a resolved set of entity-event pairs; and
d) a scoring component operative to derive a numeric score for each entity-event pair in said resolved set of entity-event pairs.

2. A method of analyzing natural language text to identify events or actions associated with specific named entities.

3. A method of determining relevance of a textual content item to entity-event pairs based on scoring the textual evidence for entities and events found in this analysis.

4. A method of automatic content mining to produce vertical market defined sector knowledge data, said method comprising the steps of:
a) receiving unstructured content documents from a plurality of sources;
b) first processing said unstructured content documents to perform term recognition to produce knowledge records including identifications of the nominative terms, predetermined characteristic of a predetermined vertical market sector, that occur in said unstructured content documents;
c) second processing said unstructured content documents and said knowledge records to perform event classification that identifies activity events correlated to said identifications of said nominative terms, wherein said event classification is operative from a predetermined rule set characteristic of said predetermined vertical market sector, wherein the results of said second processing step is stored in said knowledge records; and
d) third processing said knowledge records to score the correlated occurrences of said nominative terms and said activity events with respect to predetermined documents of said unstructured content documents, wherein the results of said third processing step is stored in a database index accessible for the reporting of market defined sector knowledge data.

5. The method of claim 4 further comprising the step of providing, to said first processing step, access to an authority database of predetermined nominative terms, predetermined characteristic of said predetermined vertical market sector.

6. The method of claim 5 further comprising the step of providing, to said second processing step, access to an event rules database storing said predetermined rule set characteristic of said predetermined vertical market sector.

7. The method of claim 6 wherein said authority database and said event rules database comprise modules of a distributed database.

8. The method of claim 7 wherein said authority database and said event rules database consist of modular subsets of a master database, wherein said master database stores identifications of nominative terms and event classification rule sets that are comprehensive to a document collection represented by said unstructured content documents.

9. The method of claim 8 wherein said receiving, first, second, and third processing steps run autonomously and wherein said method further comprises the step of continuously filtering modifications to said database index to selectively identify reportable market defined sector knowledge data.

10. The method of claim 9 wherein said step of continuously filtering provides for the filtering of modifications to said database index against personal filter profiles, wherein market defined sector knowledge data is selectively reportable on a per-user basis.

11. A knowledge mining system configurable to exclusively address a defined vertical market, said knowledge mining system comprising:
a) a distributable knowledge base including an authority file and a event category rule set, wherein said authority file includes predetermined direct and indirect identifications of nominative entities specific to a predefined vertical market and wherein said event category rule set provides query rules configured to identify predetermined activity-based events specifically related to said nominative entities;
b) a term recognition module, coupled to said distributable knowledge base, operable to produce respective evidence records identifying the occurrence and locations of nominative terms within predetermined unstructured content documents, for each of a sequence of documents provided from a document collection;
c) an event classification module, coupled to said distributable knowledge base, operable to modify respective evidence records identifying the occurrence and location of activity-based events within said predetermined unstructured content documents, for each of said sequence of documents;
d) an event resolution module, coupled to said distributable knowledge base, operable to modify respective evidence records to identify and resolve correlations of activity-based events with respect to nominative terms within said predetermined unstructured content documents, for each of said sequence of documents;
e) a scoring module operable over respective said evidence records to define relative occurrence significance scores based on the resolved correlations of nominative terms and activity-based events within said predetermined unstructured content documents, for each of said sequence of documents; and
f) a database providing for the storage of representations of said predetermined unstructured content documents and an index representative of said evidence records.
